(19) United States
(12) Patent Application Publication
(10) Pub. No.: US 2014/0262359 A1
(43) Pub. Date: Sep. 18, 2014

(54) LOW PRESSURE SPRINKLER SYSTEM FOR USE IN BUILDINGS

(71) Applicants: Guido Poncia, Glastonbury, CT (US); Enrico Manes, Feeding Hills, MA (US)

(72) Inventors: Guido Poncia, Glastonbury, CT (US); Enrico Manes, Feeding Hills, MA (US)

(21) Appl. No.: 14/351,194

(22) PCT Filed: Oct. 14, 2011
(86) PCT No.: PCT/US2011/056267

§ 371 Date: Apr. 11, 2014

(51) Int. Cl. A62C 35/64

(52) U.S. Cl. CPC A62C 35/645
USPC 169/46; 169/9

(57) ABSTRACT

An exemplary sprinkler system for use within a building includes a plurality of conduits within the building. A plurality of fixtures within the building are coupled with the conduits for providing water from the conduits to at least one individual for personal use. A plurality of sprinkler heads within the building are coupled to the conduits for selectively introducing water from the conduits into at least one portion of the building for fire suppression. A gas source is associated with the sprinkler heads for supplying gas to the sprinkler heads to achieve a fire suppression discharge from the sprinkler heads.

### BACKGROUND

A variety of sprinkler systems have proven useful for fire protection within buildings. Sprinkler heads are strategically positioned within a building so that they may discharge a fire suppression fluid when needed. Most sprinkler systems have a dedicated pipe network for carrying the fluid, such as water, to the sprinkler heads. Some sprinkler systems operate with relatively high pressures and require appropriately sized piping to withstand the necessary pressures and deliver a sufficient amount of water.

Additionally, the water pressures required by some sprinkler systems cannot be achieved without a supplemental pump or other machinery. This introduces still further costs and renders a sprinkler system undesirably expensive or impractical for many situations.

### SUMMARY

An exemplary sprinkler system for use within a building includes a plurality of conduits within the building. A plurality of fixtures within the building are coupled with the conduits for providing water from the conduits to at least one individual for personal use. A plurality of sprinkler heads within the building are coupled to the conduits for selectively introducing water from the conduits into at least one portion of the building for fire suppression. A gas source is associated with the sprinkler heads for supplying gas to the sprinkler heads to achieve a fire suppression discharge from the sprinkler heads.

An exemplary method of providing a sprinkler system within a building includes coupling a plurality of sprinkler heads to conduits within the building for selectively introducing water from the conduits into at least one portion of the building for fire suppression. Gas is supplied to the sprinkler heads for achieving a fire suppression discharge from the sprinkler heads. The conduits are also coupled to a plurality of fixtures within the building for providing water from the conduits to at least one individual for personal use.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an example sprinkler system within a building.

FIG. 2 is a partial, cross-sectional illustration of an example sprinkler head configuration.

### DETAILED DESCRIPTION

FIG. 1 schematically illustrates a sprinkler system 20 that is useful for fire suppression within a building 22. Water is provided to the building 22 from a water supply 24, which may be a municipal water supply or a well, for example. A plurality of conduits 26 are provided within the building 22 so that water is available at various locations within the building 22. In this example, a plurality of fixtures are coupled with the conduits 26 for providing water to at least one individual for personal use within the building 22. The fixtures in the illustration include faucets 28 and 30, a toilet 32 and a shower head 34. Other known fixtures for personal water use may be associated with the conduits 26 and the illustrated examples are provided for discussion purposes.

In one example, the conduits 26 comprise standard household plumbing tubing such as galvanized pipe, copper tubing or plastic tubing. The water supply 24 provides water within the conduits 26 at a typical domestic water supply pressure, which may be on the order of 40 psi to 80 psi (2800 gram-force/cm² to 5625 gram-force/cm²).

A plurality of sprinkler heads 40 are coupled to the conduits 26. The sprinkler heads 40 are strategically positioned within the building 22 to provide fire suppression utilizing water from the conduits 26. Coupling the sprinkler heads 40 to the conduits 26 used for personal water supply is a significant departure from systems that require separate, dedicated water pipes for a sprinkler system and from systems that require oversized pipes otherwise required to deliver high water flow required by many traditional sprinklers.

The sprinkler heads 40 can be referred to as twin fluid or dual fluid sprinklers because they utilize more than one fluid to achieve a desired fire suppression discharge. In some examples, one of the fluids comprises water and the other comprises a gas. The illustrated example includes a gas source 42, which may be situated within the building 22 or at a nearby location outside of the building 22.

Gas supply lines 44 couple the gas supply 42 with the sprinkler heads 40 so that a desired fire suppression discharge schematically shown at 46 is provided by the sprinkler heads 40 when the sprinkler system 20 is activated.

In one example, the sprinkler heads 40 comprise effervescent sprinkler heads that utilize effervescent atomization to provide water mist fire suppression discharge. Effervescent sprinkler heads are one example type of twin fluid sprinkler that is useful in an embodiment of this invention. One feature of the illustrated example is that the sprinkler heads 40 can operate based upon normal domestic water supply pressures and can be coupled directly to the conduits 26 used for domestic water supply purposes. There is no requirement for a pump or other device to achieve an elevated water pressure, nor is there any requirement for a separate pipe network to supply water to the sprinkler heads 40. The illustrated example allows for much more economically and easily incorporating a sprinkler system into a variety of buildings, including residential buildings.

The gas source 42 provides pressurized gas to achieve the desired fire suppression discharge from the sprinkler heads 40. The pressure in some examples is only slightly above the pressure of the water in the conduits 26. An example gas pressure is in a range from less than 1 psi (70 gram-force/cm²) above the water pressure to about 5 psi (350 gram-force/cm²) above the water pressure.

The sprinkler heads 40 achieve a desired fire suppression discharge that comprises a water mist. The discharge is achieved using relatively low water and gas pressures.

FIG. 2 schematically illustrates an example configuration of a sprinkler head 40 that is configured for effervescent atomization for achieving a water mist fire suppression discharge. This example includes a nozzle body 50 having a plurality of openings 52 and 54 through which water droplets are discharged from the sprinkler head 40 for introducing a fire suppression water mist into the appropriate portion of the building 22.

Effervescent atomization is achieved in the illustrated example as gas, such as air from the gas source 42, is introduced into a bubbler 60. A plurality of bubbler openings 62 allow air bubbles to be introduced into the water within the nozzle body 50 to create a bubbly mixture resulting in effervescent atomization and a water mist fire suppression discharge from the sprinkler head 40. Such an example sprinkler head configuration allows for using low pressure and for coupling the sprinkler heads to the conduits 26 that are used for domestic water supply, for example.

The example of FIG. 2 includes a coupling arrangement 70 having a threaded connection 72 with the nozzle body 50 and another threaded connection 74 with one of the conduits 26 from within the building 22. Other types of connections such as brazed, welded or compression fit are used in other examples. The coupling arrangement 70 includes a gas feed portion 76 configured to be connected with a gas supply line 44 to deliver gas such as air to the bubbler 60. A back flow prevention device, such as check valve schematically shown at 78, prevents any of the gas used for effervescent atomization from being introduced into the conduits 26 that are used for water supply within the building 22 for individual or personal use. Such a coupling arrangement allows for conveniently associating the sprinkler heads 40 with the conduits 26 otherwise used for domestic water supply and gas supply lines 44 to make installing the example sprinkler system 20 economical.

The disclosed example provides a low pressure, multipurpose system within a building that utilizes the same water conduits for carrying water within the building to a variety of fixtures for personal use and to a plurality of sprinkler heads for fire suppression purposes.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1. A sprinkler system for use within a building, comprising:
a plurality of conduits within the building;
a plurality of fixtures within the building and coupled to the conduits for providing water from the conduits to at least one individual for personal use;
a plurality of sprinkler heads within the building and coupled to the conduits for selectively introducing water from the conduits into at least one portion of the building for fire suppression; and
a gas source associated with the sprinkler heads for supplying gas to the sprinkler heads to achieve a fire suppression discharge of the water from the sprinkler heads.

2. The system of claim 1, comprising at least one gas supply line coupling the gas source with the sprinkler heads.

3. The system of claim 1, wherein the fire suppression discharge comprises water mist.

4. The system of claim 3, wherein the sprinkler heads comprise dual fluid sprinkler heads.

5. The system of claim 4, wherein the sprinkler heads comprise effervescent sprinkler heads.

6. The system of claim 1, wherein the conduits carry water at a domestic supply pressure and the sprinkler heads discharge water using the domestic supply pressure.

7. The system of claim 1, comprising at least one back flow prevention device that isolates the gas from the fixtures.

8. The system of claim 1, wherein the fixtures comprise at least one of a faucet, a shower head or a toilet.

9. A method of providing a sprinkler system within a building having a plurality of fixtures coupled to a plurality of conduits within the building for providing water from the conduits to at least one individual for personal use, the method comprising the steps of:
coupling a plurality of sprinkler heads to the conduits for selectively introducing water from the conduits into at least one portion of the building for fire suppression; and
supplying gas to the sprinkler heads for achieving a fire suppression discharge of the water from the sprinkler heads.

10. The method of claim 9, comprising providing at least one gas supply line between a gas source and the sprinkler heads.

11. The method of claim 9, wherein the fire suppression discharge comprises water mist.

12. The method of claim 11, wherein the sprinkler heads comprise dual fluid sprinkler heads.

13. The method of claim 12, wherein the sprinkler heads comprise effervescent sprinkler heads.

14. The method of claim 9, wherein the conduits carry water at a domestic supply pressure and the sprinkler heads use the domestic supply pressure for the fire suppression discharge.

15. The method of claim 9, comprising isolating the gas from the fixtures.

16. The method of claim 9, wherein the fixtures comprise at least one of a faucet, a shower head or a toilet.
